(19) United States
(12) Patent Application Publication
(10) Pub. No.: US 2012/0293339 A1
(43) Pub. Date: Nov. 22, 2012

(54) ELECTRONIC HOUSING INTENDED TO BE FIXED UNDER A COVER OF A MANHOLE

(76) Inventors: Christophe Milon, Lannion (FR); Mathieu Rougeolle, Lannion (FR); Jean-Claude Dubois, Lannion (FR); Philippe Guillemette, Lannion (FR)

(21) Appl. No.: 13/574,353

(22) PCT Filed: Jan. 17, 2011
(86) PCT No.: PCT/EP2011/050511

§ 371 Date: Jul. 20, 2012

(30) Foreign Application Priority Data
Jan. 21, 2010 (FR) 10/50401

(51) Int. Cl. G08C 17/00

(52) U.S. Cl. 340/870.02

(57) ABSTRACT

The invention concerns an electronic housing (100) intended to be fixed under a cover of a manhole, the cover comprising at least a first fixing means and a through cavity, the electronic housing (100) comprising:
a shell (102) having a top face,
for the or each first fixing means, a second fixing means intended to cooperate with said first fixing means in order to fix said shell (102) under the cover,
electronic components comprising a wireless communication module, and
a control module intended to change said wireless communication module from an inactive mode to an active mode,
said control module comprising a sensor able to react in the presence of a wakeup device, projecting with respect to said top face and intended to be housed in said cavity.

The present invention concerns an electronic housing placed under a cover of an inspection manhole, as well as a modular electronic assembly comprising such an electronic housing.

There exist electronic boxes, such as for example counting boxes for vehicles or pedestrians, that are placed inside the inspection manhole, to prevent external attacks.

To read the data that are stored in these electronic boxes, a technician must regularly lift the cover of the manhole and download said data from the memory of the electronic housing in question to a downloading unit, such as for example a portable computer.

The downloading takes place, for example, by means of a wireless communication, for example of the Bluetooth connection type.

Downloading the data therefore requires lifting the cover and replacing it, which constitutes a lengthy and laborious task.

One object of the present invention is to propose an electronic housing that does not have the drawbacks of the prior art and in particular enables the data that it contains to be downloaded without having to act on the cover that protects it.

To this end, an electronic counting housing is proposed, intended to be fixed under a cover of a manhole, the cover comprising at least a first fixing means and a through cavity, the electronic housing comprising:
a shell having a top face,
for the or each first fixing means, a second fixing means intended to cooperate with said first fixing means in order to fix said shell under the cover,
electronic components comprising a memory containing the counting data, and a wireless communication module intended to transmit the stored data, and
a control module intended to change said wireless communication module from an inactive mode to an active mode,

said control module comprising a sensor able to react in the presence of an external wakeup device and to cause the wireless communication module to change from the inactive mode to the active mode, said sensor projecting with respect to said top face and intended to be housed in said cavity.

Advantageously, the wireless communication module passes from the active mode to the inactive mode a certain amount of time after the transfer of the data.

According to a particular embodiment, each first fixing means is a through hole with a countersink, and each second fixing means is a screw, the head of which comes into abutment on the countersink and the threaded stem of which passes through said through hole in order to screw into the shell in a hole provided for this purpose.

According to a particular embodiment, each first fixing means and each second fixing means, associated with each other, form together an elastic connection.

Advantageously, each first fixing means is a through hole with a countersink, and each second fixing means comprises firstly a screw the head of which comes opposite said countersink and the threaded stem of which passes through said through hole in order to screw into the shell in a hole provided for this purpose, and secondly a spring arranged between said head and said countersink.

Advantageously, the electronic housing comprises a protuberance in which the sensor is embedded.

Advantageously, the shape of the protuberance matches the shape of the cavity.

Advantageously, the protuberance is produced from a flexible material.

Advantageously, the protuberance is transparent in the wavelength range used.

Advantageously, the inside of the shell is divided into a central compartment intended to receive the electronic components and at least one lateral compartment intended to receive an electrical energy source.

Advantageously, the electronic components are embedded in a resin filling said central compartment.

The invention also proposes a modular electronic assembly comprising an electronic housing according to one of the preceding variants and a complementary electronic housing fixed removably under said electronic housing.

Advantageously, the fixing takes place by means of a bayonet fixing system.

The features of the invention mentioned above, as well as others, will emerge more clearly from a reading of the following description of an example embodiment, said description being given in relation to the accompanying drawings, among which:

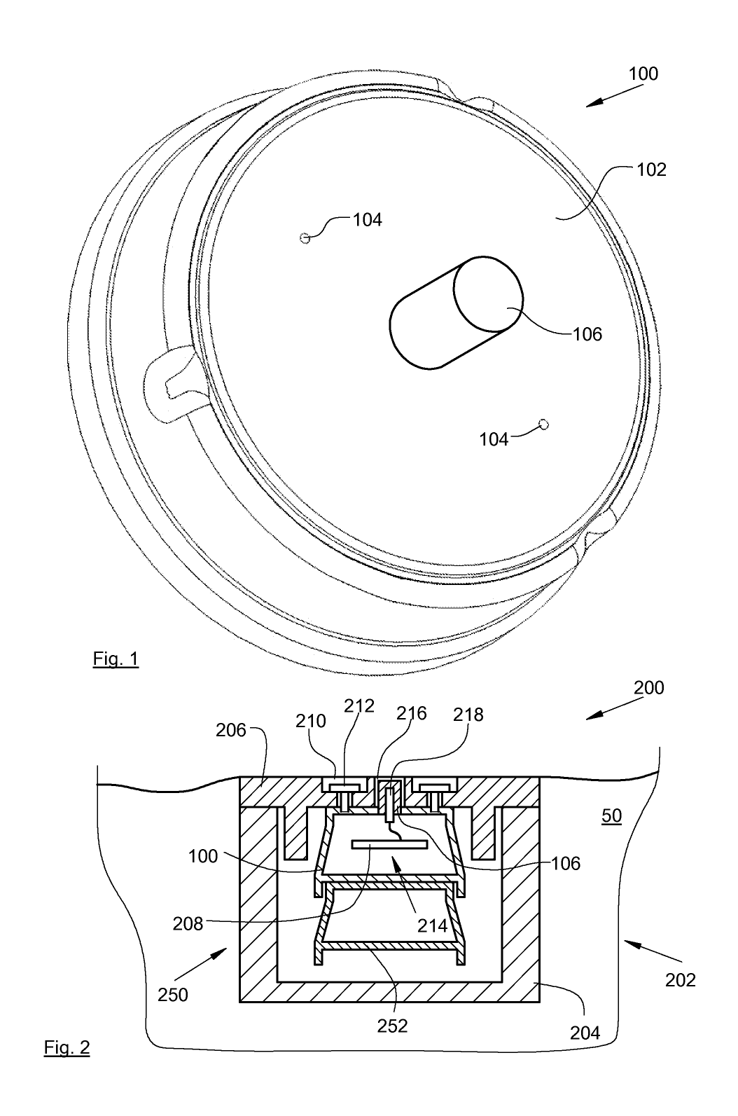

FIG. 1 shows an electronic housing according to the invention,

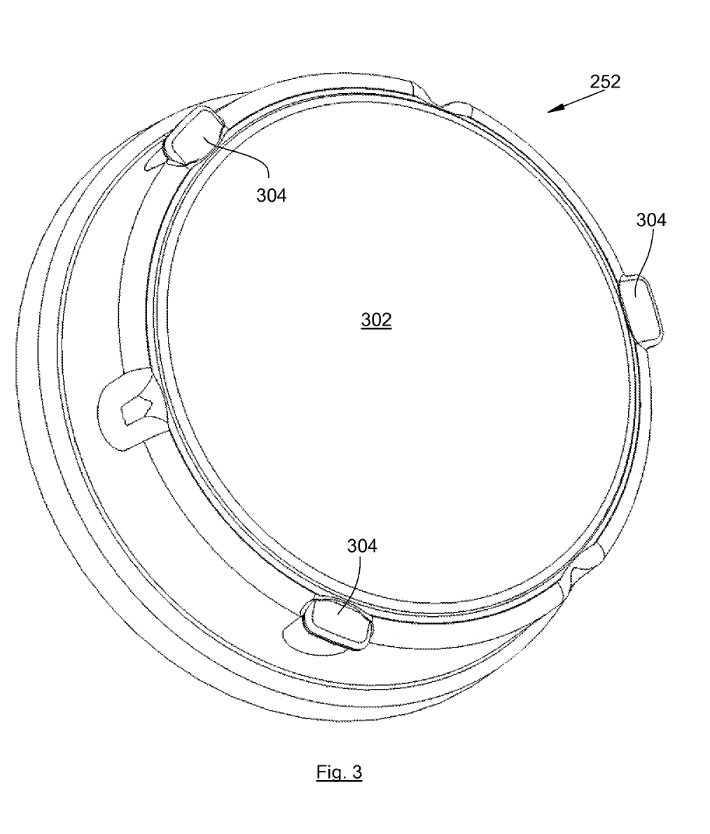

FIG. 2 is a view in section of an example layout of the electronic housing of FIG. 1,

FIG. 3 shows a complementary electronic housing for a modular electronic assembly according to the invention,

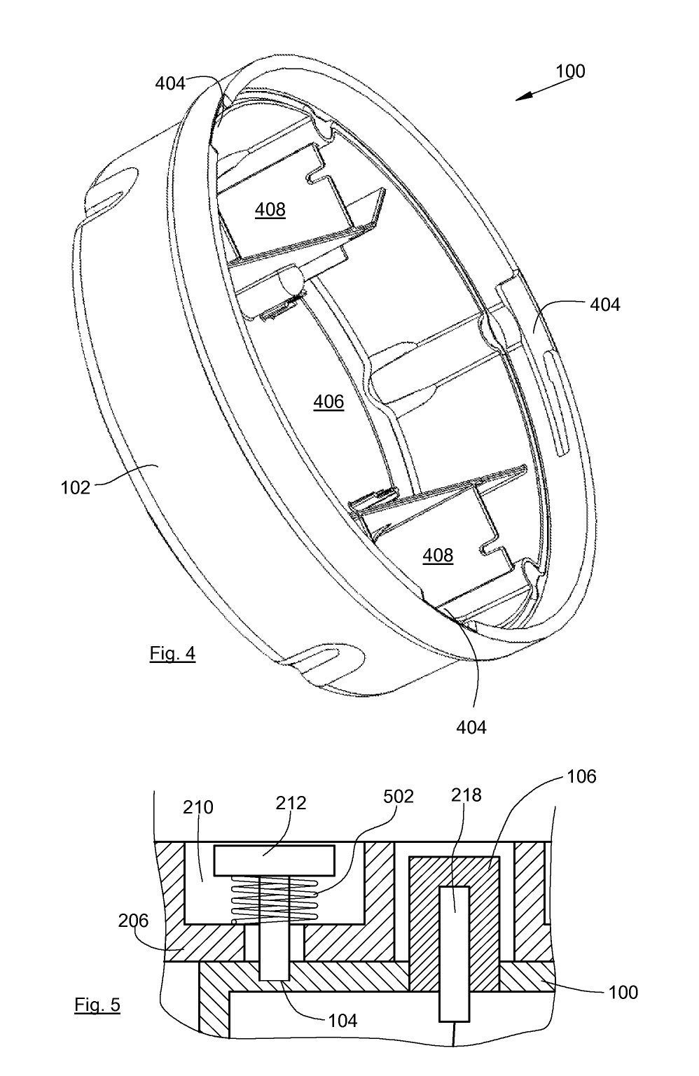

FIG. 4 is a view from below of the electronic housing of FIG. 1, and

FIG. 5 shows a variant layout of the electronic housing according to the invention.

In the following description, the terms relating to a position are taken with reference to an electronic housing placed vertically, that is to say as it is shown in FIG. 2.

FIG. 1 shows an electronic housing 100 according to the invention.

FIG. 2 shows an example layout 200 of the electronic housing 100 in a manhole 202 placed in the ground 50.

The manhole 202 is here in the form of a cylinder 204 and a cover 206.

The electronic housing 100 may be any device to which a technician must have access in order to check it or with which he must enter into communication in order to recover data that its memory contains.

The electronic housing 100 may be a housing for counting vehicles or pedestrians, an electric meter, a gas meter, a water meter, etc.

Inside the electronic housing 100 the electronic components 208 necessary for its functioning are arranged.

The electronic housing 100 comprises a shell 102 that is in the form of an inverted bowl, that is to say the bottom of the bowl is situated at the top and constitutes the top face of the shell 102 and the opening of the bowl is situated at the bottom, which prevents infiltrations of water by trickling.

To close the opening of the shell 102, the electronic housing 100 comprises a wall mounted removably under the shell 102. To provide watertightness of the electronic housing 100, a silicone gasket is placed around the wall thus mounted.

To prevent the electronic housing 100 being at the bottom of the manhole 202, which may be flooded, the electronic housing 102 is fixed under the cover 206.

For this purpose the cover 206 has at least one first fixing means 210, and the electronic housing 100 comprises, for each first fixing means 210, a second fixing means 212, intended to cooperate with said first fixing means 210 in order to fix the electronic housing 100 under the cover 206.

In the embodiment of the invention presented in FIGS. 1 and 2, the first fixing means 210 are two in number and each take the form of a through hole 210 with a countersink, and each second fixing means 212 takes the form of a screw, the head of which comes into abutment on the countersink and the threaded stem of which passes through said through hole in order to screw into the shell 102 in a hole 104 provided for this purpose.

In the case of an electrical housing 100, the data of which must be read through a wireless communication, the electronic components 208 comprise a wireless communication module, for example of the radio (Bluetooth) or light (infrared) etc communication module type.

In the case of a self-powered electronic housing 100, that is to say one including its own energy source, the electrical consumption must be limited in order to guarantee greater life of the energy source.

However, a wireless communication module consumes a great deal of energy and, in order to limit its consumption, the electronic housing 100 also comprises a control module 214 intended to change the wireless communication module from an inactive mode to an active mode.

In active mode, the wireless communication module is operational and able to transmit data and receive instructions.

In inactive mode, the wireless communication module is not operational.

To read the counting data stored in the memory of the electronic housing 100, the technician must act on the control module 214 that controls the change of the wireless communication module from inactive mode to active mode.

When the wireless communication module is active, the technician reads the data, using for example a computer or the like connected to said wireless communication module through a wireless connection. The wireless communication module thus transmits the stored data.

In order to be able to act on the control module 214, the latter must be at least partly accessible from the outside of the manhole 202.

For this purpose, the manhole 202, and more particularly the cover 206, comprises a cavity 216 that takes the form of a hole passing through the cover 202, and the control module 214 comprises a sensor 218 of the contactless sensor type, such as for example a magnetic sensor, which projects with respect to the top face of the shell 102 and is housed in the cavity 216.

The sensor 218 may for example be a switch with a flexible blade, also referred to as an “ILS” or “reed switch”.

The sensor 218 is designed to react in the presence of a contactless external wakeup device, such as for example a magnetic key.

For reasons of mechanical protection, the sensor 218 must remain inside the cavity 216 and not emerge out of the manhole 202. The first fixing means 210 and the second fixing means 212 are designed to allow the adjustment of the position of the electronic housing 100 under the cover 206 so that the sensor 218 does not emerge out of the manhole 202.

Thus, when a technician wishes to read the data stored in the electronic housing 100, he approaches the wakeup device of the sensor 218, which actuates the sensor 218 and triggers, in the control module 214, the command causing the wireless communication module to change from inactive mode to active mode.

After the transfer of the data and after a certain amount of time, the wireless communication module changes from active mode to inactive mode.

The placing of the sensor 218 in the cavity 216 in the cover 206 therefore makes it possible to switch the wireless communication module from inactive mode to active mode, and to download the data contained in the electronic housing 100 without having to manipulate the cover 206.

To protect the sensor 218, this is embedded in a protuberance 106.

To prevent foreign bodies being inserted between the protuberance 106 and the wall of the cavity 216, the shape of the protuberance 106 matches the shape of the cavity 216.

In the embodiment of the invention presented in FIGS. 1 and 2, the protuberance 106 takes the form of a cylinder.

It is possible that a foreign body, such as a pebble, may come to be housed at the top of the protuberance, and that a vehicle or pedestrian may crush the pebble on the protuberance 216. To prevent the protuberance 216 breaking under the action of the pebble, it is produced from a flexible material such as for example a thermoplastic elastomer of the SEBS type with a hardness of around 60 Shore.

It is also possible to provide for the electronic components 208 to include diodes, whether it be light emitting diodes that switch on in order to inform the technician on the state of the control module 214 and/or of the wireless communication module, or whether it be infrared communication diodes. For this purpose, the protuberance 216 is transparent in the wavelength range used and serves to guide the waves from the diodes to the outside and vice versa.

The electronic housing 100 can be associated with at least one complementary electronic housing 252 in order to constitute a modular electronic assembly 250.

FIG. 3 shows the shell 302 of the complementary electronic housing 252 and FIG. 4 shows the opening in the shell 102 of the electronic housing 100.

The complementary electronic housing 252 may be of the same type as the electronic housing 100 and is preferably electronically connected to the latter by a connection cable in order to be able to communicate with it or with the computer of the technician.

The modular electronic assembly 250 takes the form of a column that consists here of the electronic housing 100 and the complementary electronic housing 252, which are fixed removably one above the other.

The shell 302 of the complementary electronic housing 252 has the same shape as the shell 102 of the electronic housing 100. The shells 102 and 302 have a profile that splays towards their respective openings, and thus the fitting of the electronic housing 100 on the complementary electronic housing 252 is facilitated.

The fixing of the complementary electronic housing 252 under the electronic housing 100 is effected by means of a bayonet fixing system.

The shell 302 has at least two bayonets 304 that project towards the outside of the shell 302 at the top thereof.

For each bayonet 304, the electronic housing 100 comprises, at its opening, a slot 404 intended to receive said bayonet 304 and to hold it after a rotation of the complementary electronic housing 252. To effect a self-clamping locking, the widths of the slots 404 narrow in order to equip the bayonets 304.

Naturally the complementary electronic housing 252 also comprises the same slots 404 to allow the optional fixing of another complementary electronic housing.

The inside of the shell 102, 302 is divided into a plurality of compartments. In particular, the plurality comprises a central compartment 406 and two lateral compartments 408 arranged on either side of the central compartment 406.

The central compartment 406 is intended to receive the electronic components 208, which are embedded in a resin filling said compartment in order to provide good watertightness.

Each lateral compartment 408 is intended to receive an electrical energy source, such as a battery.

FIG. 5 shows an electronic housing 100 that is designed so as to be fixed elastically under the cover 206. The implementation of an elastic connection facilitates the pressing in of the electronic housing 100 when an external element bears thereon, for example on the protuberance 106, whether or not the latter be produced from a flexible material.

For this purpose, each first fixing means 210 and each associated second fixing means 212, 502 form together said elastic connection.

In the embodiment of the invention presented in FIG. 5, each first fixing means 210 is a through hole with a countersink, and each second fixing means 212, 502 comprises firstly a screw 212 the head of which comes opposite said countersink and the threaded stem of which passes through said through hole in order to be screwed in the shell 102 in the hole 104 provided for this purpose, and secondly a spring 502 placed between the screw head and the countersink.

The spring 502 is here a helical compression spring, but it may take another form as long as the downward movement and the return to the initial position of the electronic housing 100 are ensured.

Naturally, the present invention is not limited to the examples and embodiments described and depicted but is capable of numerous variants accessible to a person skilled in the art.

1-13. (canceled)

14. Electronic counting housing intended to be fixed under a cover of a manhole, the cover comprising at least a first fixing means and a through cavity, the electronic housing comprising:
a shell having a top face,
for the or each first fixing means, a second fixing means intended to cooperate with said first fixing means in order to fix said shell under the cover,
electronic components comprising a memory containing the counting data, and a wireless communication module intended to transmit the stored data, and
a control module intended to change said wireless communication module from an inactive mode to an active mode,
said control module comprising a sensor able to react in the presence of an external wakeup device and to cause the wireless communication module to change from the inactive mode to the active mode, said sensor projecting with respect to said top face and intended to be housed in said cavity.

15. Electronic counting housing of claim 14, wherein the wireless communication module goes from the active mode to the inactive mode, a certain amount of time after the data are transferred.

16. Electronic housing of claim 14, wherein each first fixing means is a through hole with a countersink, and wherein each second fixing means is a screw the head of which comes into abutment on the countersink and the threaded stem of which passes through said through hole in order to be screwed into the shell in a hole provided for this purpose.

17. Electronic housing of claim 14, wherein each first fixing means and each associated second fixing means form together an elastic connection.

18. Electronic housing of claim 17, wherein each first fixing means is a through hole with a countersink, and wherein each second fixing means comprises firstly a screw the head of which comes opposite said countersink and the threaded stem of which passes through said through hole in order to be screwed into the shell in a hole provided for this purpose, and secondly a spring placed between said head and said countersink.

19. Electronic housing of claim 14, wherein it comprises a protuberance in which the sensor is embedded.

20. Electronic housing of claim 19, wherein the shape of the protuberance matches the shape of the housing.

21. Electronic housing of claim 19, wherein the protuberance is produced from a flexible material.

22. Electronic housing of claim 19, wherein the protuberance is transparent in the range of wavelengths used.

23. Electronic housing of claim 14, wherein the interior of the shell is divided into a central compartment intended to receive the electronic components and at least one lateral compartment intended to receive an electrical energy source.

24. Electronic housing of claim 23, wherein the electronic components are embedded in a resin filling said central compartment.

25. Modular electronic assembly comprising an electronic housing according to claim 14 and a complementary electronic housing fixed removably under said electronic housing.

26. Modular electronic assembly according to claim 25, wherein the fixing takes place by means of a bayonet fixing system.
